(19) United States
(12) Patent Application Publication
(10) Pub. No.: US 2005/0056803 A1
(43) Pub. Date: Mar. 17, 2005

(54) Pressure-control valve for an accumulator fuel-injection system

(76) Inventors: Gerhard Geyer, Stuttgart (DE); Helmut Sattmann, Eferding (AT); Christian Braeuer, Steyr (AT); Thomas Buchberger, Linz (AT); Frank Haerer, Lorch-Waldhausen (DE)

Correspondence Address: RONALD E. GREIGG;GREIGG & GREIGG P.L.L.C., 1423 Powhatan Street, Suite One, Alexandria, VA, 22314, US

(21) Appl. No.: 10/940,973

(22) Filed: Sep. 15, 2004

(30) Foreign Application Priority Data
Sep. 15, 2003 (DE) 1 03 42 550.0

(51) Int. Cl. F16K 31/02

(52) U.S. Cl. 251/129.15; 123/458

(57) ABSTRACT

A pressure-control valve for regulating the pressure in a fuel accumulator having a piston-shaped valve member guided axially displaceable in a bore and acts on a closing element which can be pressed against a valve seat. The valve member constitutes an armature of an electromagnet which can be supplied with electrical current. The valve is additionally equipped with a mechanical spring which presses the valve member in the direction toward the valve seat and whose initial spring tension is such that the spring pressure corresponds to the maximum desired pressure in the fuel accumulator. In this way a pressure is generated at the valve outlet and therefore an injection process is made possible, even in case of a failure of the electromagnetic regulation.

### BACKGROUND OF THE INVENTION

1. Field of the Invention

The invention relates to an accumulator fuel-injection system for internal combustion engines, having a pressure-control valve for regulating the pressure in a fuel accumulator and having a piston-shaped valve member, which is guided, axially displaceable, in a bore, which acts on a closing element in the closing direction, and presses it against a valve seat, wherein the valve member constitutes an armature of an electromagnet, which can be supplied with current.

2. Description of the Prior Art

Pressure control valves are known in many embodiments for use in regulating the pressure in a fuel accumulator with which it is connected via an inlet. The pressure-control valve has a piston-shaped valve member guided axially displaceable in a bore and can move against a force, which preferably acts on the valve member by means of the current in an electromagnet. The force acts in the closing direction, so that the valve member is pushed on a closing element of the pressure-control valve and is pressed against a valve seat. The valve member constitutes an armature of the electromagnet, which can be supplied with current for controlling the force.

By means of the applied current, the closing element is pushed via the valve member against the valve seat with a defined force, wherein the closing element is lifted off the valve seat by the pressure acting on it in the fuel accumulator if the force generated by the pressure exceeds the closing force exerted on the closing element by the valve member. In that case fuel flows out of the fuel accumulator through the inlet via the opened pressure-control valve into a relief chamber.

If a higher pressure occurs in the fuel accumulator, the current in the electromagnet is increased, so that the closing force is increased and therefore the closing element is lifted off the valve seat only in case of a higher pressure in the fuel accumulator, so that fuel can flow from the fuel accumulator into the relief chamber.

In addition, the valve is often provided with a mechanical spring, which in the position of rest, i.e. while the engine is stopped, assures that the valve is closed and no fuel penetrates into the relief chamber. However, the mechanical spring force of this spring can easily be overcome by a slight fuel pressure. Then the build-up of a sufficiently large pressure in the fuel accumulator does not occur. The required minimum pressure in the fuel accumulator is only assured by the effects of the electromagnetically generated closing force.

This spring can also be laid out in such a way that the valve can only be opened at a defined minimum pressure.

If a functional interference with the electrical current supply to the electromagnet occurs in these known devices, for example because of the loosening of the appropriate plug, and therefore the electromagnetic closing force is interrupted, fuel can enter into the relief chamber at low pressure and therefore make the injection impossible. In that case driving is no longer possible.

### OBJECT AND SUMMARY OF THE INVENTION

It is the object of the invention to further develop the pressure-control valve known from the prior art in such a way that it generates a sufficiently high pressure at the valve outlet, even if the electrical current supply fails, and in this way makes unregulated emergency driving operations possible. This object is attained by the design of the pressure-regulating valve which makes an injection process possible even without the electrical current regulation of the pressure-control valve, and therefore also allows emergency driving.

A force acts on the valve member of the pressure-control valve because of the pressure in the fuel accumulator. If this force created by hydraulic pressure is greater than the force acting on the valve member in the closing direction, the valve member is lifted off the valve seat and opens the pressure-control valve. The closing force of the valve is supplied by the mechanical spring alone. An electrical current supply for the electromagnet for closing the pressure-control valve is not necessary.

The regulation of the injection pressure takes place independently thereof by means of the electrical current supply to the electromagnet. For this purpose the electromagnet has been set in such a way that in case of an electrical current increase a magnetic force acts in the direction of the hydraulic force. Thus, the closing force of the valve is reduced by the control.

On the other hand, the spring force of the mechanical spring permits driving also without the electrical current supply and, on the other hand, limits the maximum pressure in the fuel accumulator regardless of whether an electrical current supply is provided or not.

### BRIEF DESCRIPTION OF THE DRAWINGS

Other features and advantages of the invention will be apparent from the description contained herein below, taken with the single drawing FIGURE which is a section through the pressure-control valve in accordance with the invention.

### DETAILED DESCRIPTION OF THE PREFERRED EMBODIMENT

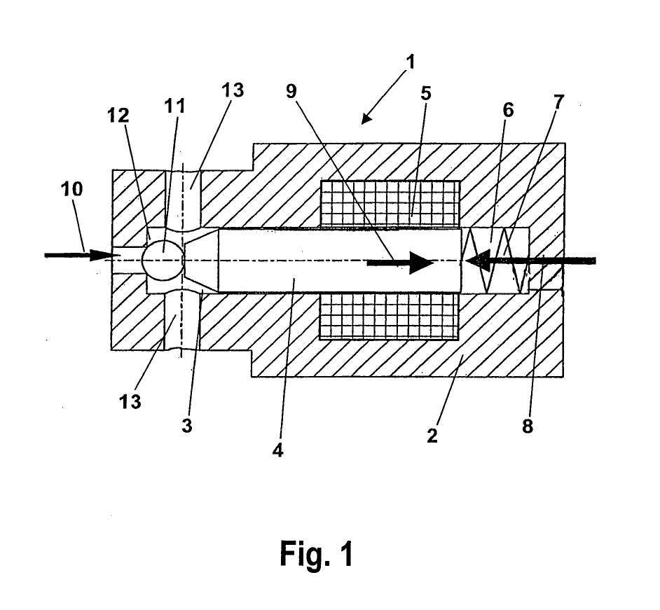

A longitudinal section through a pressure-control valve 1 is represented in FIG. 1, which can be arranged at the outlet of a high-pressure pump, not represented in the drawing FIGURE, or at a fuel accumulator, also not represented.

The pressure-control valve 1 itself has a valve body 2 having a bore 3 in which a piston-shaped valve member 4 is axially displaceably arranged. In addition, a further space is provided inside the valve body 2, in which an electromagnet 5 with a wire-wound coil is arranged.

A mechanical spring 7, which is embodied as a helical spring, for example, is provided in a recess 6 and exerts a spring force in the closing direction 8 on the valve member 4. The spring constant is designed in such a way that the spring 7 alone assures the closing of the pressure-control valve 1, as long as the maximum pressure desired in the fuel accumulator is not exceeded.

A magnetic force 9 in the direction of the hydraulic force 10 is caused by supplying the electromagnet 5 with electrical current. When increasing the electrical regulating current, the valve member 10 is pressed with less force against the closing element 11, and the latter against the valve seat 12.

Because of their own weight and because of the spring effect of the mechanical spring 7, the valve member 4, or the closing element 11, rest on the valve seat 12. At the same time the closing element 11 is acted upon by the hydraulic pressure 10 in the fuel accumulator and by a magnetic force 9 created by the electromagnet.

The hydraulic pressure 10 should not exceed a defined pressure in the fuel accumulator. This threshold value can be regulated by means of supplying electrical current to the electromagnet 5, and it is determined from the difference between the spring force in the closing direction 8 and the magnetic force 9. If the threshold value is exceeded, the hydraulic pressure 10 is sufficient for opening the pressure-control valve 1, and the fuel can flow through the outlet openings 13 into a compensating container, not represented in the drawing FIGURE.

In case the electromagnet 5 fails, the maximum pressure can no longer be regulated. But pressure can still build up in the fuel accumulator, since the pressure-control valve 1, which is no longer supplied with electrical current, only opens at a maximum pressure defined by the spring force 8 of the mechanical spring 7.

In this way the injection process and driving is also made possible in case of a disruption of the function of the electrical current supply for the electromagnet 5.

The foregoing relates to preferred exemplary embodiments of the invention, it being understood that other variants and embodiments thereof are possible within the spirit and scope of the invention, the latter being defined by the appended claims.

1. A pressure-control valve (1) for an accumulator fuel-injection system for internal combustion engines for regulating the pressure in a fuel accumulator, comprising a piston-shaped valve member guided, axially displaceable, in a bore, which acts on a closing element, which can be pressed against a valve seat, wherein the valve member constitutes an armature of an electromagnet, which can be supplied with current, and a mechanical spring (7), which presses the valve member (4) in the direction toward the valve seat (12), the mechanical spring (7) having an initial spring tension designed in such a way that the spring pressure (8) corresponds to the maximum desired pressure in the fuel accumulator.

2. The pressure-control valve in accordance with claim 1, wherein the regulation of the pressure below the desired pressure in the fuel accumulator takes place by providing the electromagnet (5) with electrical current, which results in a magnetic force in the direction of the hydraulic pressure (10).
